(19) United States
(12) Patent Application Publication
(10) Pub. No.: US 2021/0049403 A1
(43) Pub. Date: Feb. 18, 2021

(54) METHOD AND DEVICE FOR IMAGE PROCESSING, ELECTRONIC DEVICE, AND STORAGE MEDIUM

(71) Applicant: Beijing Sensetime Technology Development Co., Ltd., Beijing (CN)

(72) Inventors: Xingang PAN, Beijing (CN); Ping LUO, Beijing (CN); Jianping SHI, Beijing (CN); Xiaoou TANG, Beijing (CN)

(73) Assignee: Beijing Sensetime Technology Development Co., Ltd., Beijing (CN)

(21) Appl. No.: 17/086,713

(22) Filed: Nov. 2, 2020

Related U.S. Application Data
(63) Continuation of application No. PCT/CN2019/121180, filed on Nov. 27, 2019.

(30) Foreign Application Priority Data
Mar. 30, 2019 (CN) 201910253934.9

(51) Int. Cl. G06K 9/54; G06K 9/46; G06K 9/62; G06K 9/42; G06N 3/04; G06N 3/08

(52) U.S. Cl. CPC G06K 9/54; G06K 9/46; G06K 9/623; G06N 3/084; G06K 9/6262; G06K 9/42; G06N 3/04; G06K 9/6256

(57) ABSTRACT

A method for image processing, an electronic device, and a storage medium are provided. The method includes the following. For each processing method in a preset set of processing methods, a first feature parameter and a second feature parameter are determined according to image data to-be-processed, where the preset set includes at least two processing methods selected from whitening methods and/or normalization methods, and the image data to-be-processed includes at least one image data. A first weighted average of the first feature parameters is determined according to a weight coefficient of each first feature parameter, and a second weighted average of the second feature parameters is determined according to a weight coefficient of each second feature parameter. The image data to-be-processed is whitened according to the first weighted average and the second weighted average.

### CROSS-REFERENCE TO RELATED APPLICATION(S)

This application claims priority under 35 U.S.C. § 120 as a continuation of International Application No. PCT/CN2019/121180, filed Nov. 27, 2019, which in turn claims priority under 35 U.S.C. § 119(a) and/or PCT Article 8 to Chinese Patent Application No. 201910253934.9 filed, Mar. 30, 2019, the entire disclosures of which are hereby incorporated by reference in their entireties.

### TECHNICAL FIELD

This disclosure relates to the technical field of computer vision, particularly to a method and a device for image processing, an electronic device, and a storage medium.

### BACKGROUND

Convolutional neural networks have become the mainstream method in the field of computer vision. For different computer vision tasks, researchers have developed different normalization and whitening methods. Image normalization is the process of centralizing data through de-averaging. According to convex optimization theory and related knowledge of data probability distribution, data centralization conforms to the law of data distribution, which is easier to obtain generalization effects after training. Data normalization is one of common methods of data preprocessing. The purpose of whitening is to remove redundant information in input data.

It can be seen that the application of normalization and whitening in computer vision tasks is important. At present, various normalization and whitening methods in image processing have their own advantages and disadvantages, and the effect of image processing is not comprehensive enough. In addition, there is large space and difficulty in design of convolutional neural network models.

### SUMMARY

In a first aspect, a method for image processing is provided. The method includes the following. For each processing method in a preset set of processing methods, a first feature parameter and a second feature parameter are determined according to image data to-be-processed, where the preset set includes at least two processing methods selected from whitening methods and/or normalization methods, and the image data to-be-processed includes at least one image data. A first weighted average of the first feature parameters is determined according to a weight coefficient of each first feature parameter, and a second weighted average of the second feature parameters is determined according to a weight coefficient of each second feature parameter. The image data to-be-processed is whitened according to the first weighted average and the second weighted average.

In at least one implementation, the first feature parameter is an average vector and the second feature parameter is a covariance matrix.

In at least one implementation, whitening the image data to-be-processed is executed by a neural network.

In at least one implementation, the method further includes the following. For each processing method in the preset set, a weight coefficient of a first feature parameter of the processing method in the preset set is determined according to a normalized exponential function by utilizing a value of a first control parameter of the processing method in the neural network. For each processing method in the preset set, a weight coefficient of a second feature parameter of the processing method in the preset set is determined according to the normalized exponential function by utilizing a value of a second control parameter of the processing method in the neural network.

In at least one implementation, first control parameters and second control parameters of the processing methods in the preset set are obtained as follows. Based on a back propagation approach for the neural network, first control parameters, second control parameters, and network parameters of a neural network to-be-trained are jointly optimized by minimizing a value of a loss function of the neural network to-be-trained. Values of the first control parameters corresponding to the smallest value of the loss function of the neural network to-be-trained are assigned to values of first control parameters of a trained neural network. Values of the second control parameters corresponding to the smallest value of the loss function of the neural network to-be-trained are assigned to values of second control parameters of the trained neural network.

In at least one implementation, based on the back propagation approach for the neural network, the first control parameters, the second control parameters, and the network parameters of the neural network to-be-trained are jointly optimized by minimizing the value of the loss function of the neural network to-be-trained as follows. The neural network to-be-trained whitens image data for training according to the first weighted average and the second weighted average, and outputs a prediction result, where an initial value of a first control parameter of a first processing method in the preset set is a first preset value, and an initial value of a second control parameter of the first processing method in the preset set is a second preset value. The value of the loss function of the neural network to-be-trained is determined according to the prediction result output by the neural network to-be-trained and an annotation result of the image data for training. Values of the first control parameters, the second control parameters, and the network parameters of the neural network to-be-trained are adjusted according to the value of the loss function of the neural network to-be-trained.

In at least one implementation, the image data to-be-processed is whitened according to the first weighted average and the second weighted average as follows. Each image data in the image data to-be-processed is whitened according to the first weighted average, the second weighted average, and the number of channels, the height, and the width of the image data to-be-processed.

In at least one implementation, the normalization method includes at least one of: batch normalization, instance normalization, and layer normalization.

In at least one implementation, the whitening method includes at least one of: batch whitening and instance whitening.

In a second aspect, an electronic device is provided. The electronic device includes at least one processor and a non-transitory computer readable storage. The computer readable storage is coupled to the at least one processor and stores at least one computer executable instruction thereon which, when executed by the at least one processor, causes the at least one processor to execute the method of the first aspect.

In a third aspect, a non-transitory computer readable storage medium is provided. The non-transitory computer readable storage medium is configured to store a computer program which, when executed by a processor, causes the processor to execute the method of the first aspect.

### BRIEF DESCRIPTION OF THE DRAWINGS

The drawings herein are incorporated into the specification and constitute a part of the specification. These drawings illustrate implementations that conform to the disclosure and are used together with the specification to explain the technical solutions of the disclosure.

FIG. 1 is a schematic flow chart illustrating a method for image processing according to implementations of this application.

FIG. 2 is a schematic flow chart illustrating a method for training control parameters according to implementations of this application.

FIG. 3 is a schematic diagram illustrating visualization of style transfer using different normalization layers according to implementations.

FIG. 4 is a schematic structural diagram illustrating a device for image processing according to implementations.

FIG. 5 is a schematic structural diagram illustrating an electronic device according to implementations.

### DETAILED DESCRIPTION

To assist those of ordinary skill in the art to understand technical solutions of this application, the technical solutions in implementations of the present disclosure will be described clearly and completely hereinafter with reference to the accompanying drawings. It is understood that the described implementations are merely some rather than all implementations of the present disclosure. All other implementations obtained by those of ordinary skill in the art based on the implementations of the present disclosure without creative efforts shall fall within the protection scope of the present disclosure.

The terms “first” and “second” used in the specification, the claims, and the accompanying drawings of the present disclosure are used to distinguish different objects rather than to describe a particular order. In addition, the terms “include”, “comprise”, and “have” as well as variations thereof are intended to cover non-exclusive inclusion. For example, a process, method, system, product, or apparatus including a series of operations or units is not limited to the listed operations or units; it can optionally include other operations or units that are not listed; alternatively, other operations or units inherent to the process, method, product, or device can be included either.

The term “implementation” referred to herein means that a particular feature, structure, or feature described in connection with the implementation may be contained in at least one implementation of the present disclosure. The phrase appearing in various places in the specification does not necessarily refer to the same implementation, nor does it refer an independent or alternative implementation that is mutually exclusive with other implementations. It is expressly and implicitly understood by those of ordinary skill in the art that an implementation described herein may be combined with other implementations.

The device for image processing of implementations of this application may allow access of multiple other terminal devices. The device for image processing may be an electronic device, including a terminal device. For example, the terminal device includes but is not limited to other portable devices such as a mobile phone, a laptop computer, or a tablet computer with a touch-sensitive surface (e.g., a touch screen display and/or a touch pad). It should also be understood that, in some examples, the device is not a portable communication device, but a desktop computer with a touch-sensitive surface (e.g., a touch screen display and/or a touch pad).

The concept of deep learning of the implementations of this application originates from research of artificial neural networks. A multilayer perceptron with multiple hidden layers is a structure of deep learning. Deep learning forms a more abstract high-level representation attribute category or feature by combining low-level features, to discover distributed feature representation of data.

Deep learning is a method of machine learning based on representation learning of data. Observations (such as an image) can be represented in a variety of ways, such as represented as a vector of an intensity value of each pixel, or more abstractly represented as a series of edges, regions of specific shapes, and so on. By using specific representation methods, it is easier to learn tasks (for example, face recognition or facial expression recognition) from instances. The advantage of deep learning is to use efficient approaches based on unsupervised or semi-supervised feature learning and hierarchical feature extraction to replace manual feature acquisition. Deep learning is a new field in machine learning research. Its motivation lies in establishing and simulating a neural network for analysis and learning of a human brain. It mimics mechanism of the human brain to interpret data, such as images, sounds and texts.

The following describes implementations of this application in detail.

FIG. 1 is a schematic flow chart illustrating a method for image processing according to implementations of this application. As illustrated in FIG. 1, the method can be executed by the above device for image processing and begins at 101.

At 101, for each processing method in a preset set of processing methods, a first feature parameter and a second feature parameter are determined according to image data to-be-processed, where the preset set includes at least two processing methods selected from whitening methods and/or normalization methods, and the image data to-be-processed includes at least one image data.

The normalization on image data is also called standardization, which is a basic work of data mining. Different evaluation indicators often have different dimensions and dimensional units, which will affect results of data analysis. In order to eliminate influence between indicators in dimension, data normalization is required to solve comparability between indicators of data. After the original data is subjected to data normalization, various indicators are in the same order of magnitude, suitable for comprehensive comparative evaluation.

The final imaging of an image will be affected by many factors such as ambient lighting intensity, object reflection, and shooting camera. In order to obtain constant information contained in the image that is not affected by the outside, the image need to be whitened.

The “image whitening” referred to herein can be used to process over-exposure or low-exposure pictures. Generally, in order to remove influence of exposure factors, an average pixel value of the image is changed to 0 and a variance of the image is changed to unit variance of 1. Such change can be achieved through an average vector (or mean vector) and a covariance matrix, that is, converting mean and variance of pixel values into zero and one.

For different computer vision tasks, researchers have developed different normalization methods and whitening methods. For example, batch normalization and batch whitening are used in tasks such as image classification and object detection; instance normalization and instance whitening are used in image style transfer and image generation; layer normalization is used in recurrent neural networks.

For ease of illustration, batch whitening, instance whitening, batch normalization, instance normalization, and layer normalization herein may be shortened to bw, iw, bn, in, and ln, respectively.

In the implementation, the set of processing methods can be set in advance. Which whitening method(s) and/or normalization method(s) are included in the set of processing methods can be determined according to the image data to-be-processed. For example, the set of processing methods can include batch normalization, batch whitening, instance normalization, instance whitening, and layer normalization, or include only some of the methods, but should include at least two of the whitening methods and/or the normalization methods.

First, according to the image data to-be-processed and each processing method in the preset set, the first feature parameter and the second feature parameter of each processing method are determined, that is, feature parameters for weighted averaging are obtained.

The operations of the implementations may be implemented based on a trained convolutional neural network (CNN). CNN is a type of feed forward neural networks that includes convolution calculations and has a deep structure, and is one of representative approaches of deep learning.

At operation 101, based on calculation formulas of the processing methods, the first feature parameters and the second feature parameters of the processing methods are obtained. Since the set of processing methods includes at least two processing methods, at least two first feature parameters and at least two second feature parameters are obtained. For image whitening or image normalization, the first feature parameter output can be an average vector and the second feature parameter output can be a covariance matrix. That is, the device for image processing can acquire at least two average vectors and at least two covariance matrices of the image data to-be-processed, which are obtained based on image data and the preset processing methods.

A weighted average of average vectors is

$$\hat{μ} = {\sum }_{k ∈ Ω} {ω}_{k} {μ}_{k} ,$$

where Ω is the above set of processing methods, ωₖ is a first weight coefficient, and μₖ is an average vector of each processing method in the set of processing methods.

A weighted average of covariance matrices is

$$\hat{Σ} = {\sum }_{k ∈ Ω} {ω}_{k}^{′} {Σ}_{k} ,$$

where Ω the above set of processing methods, ωₖ′ is a second weight coefficient, and Σₖ is the above covariance matrix.

In at least one example, the preset set of processing methods can include batch whitening. A first feature parameter and a second feature parameter of batch whitening are calculated via the following formulas:

$${μ}_{b w} = \frac{1}{NHW} X \cdot 1 ; {Σ}_{b w} = \frac{1}{NHW} ( X - μ \cdot {1}^{T} ) {( X - μ \cdot {1}^{T} )}^{T} + ɛ I ;$$

where μ_{bw} is the first feature parameter (such as average vector) of batch whitening, Σ_{bw} is the second feature parameter (such as covariance matrix) of batch whitening, X is a batch of image data in the image data to-be-processed, X ∈ R^{X×NHW}, N is the number of the image data, 1 is a column vector of all ones, I is an identity matrix in which diagonal elements are 1 and the rest are 0, and ε is a positive number.

ε can be a small positive number to prevent a singular covariance matrix. In batch whitening, the whole batch of data is whitened, i.e., ϕ(X)ϕ(X)^{T}=I.

In at least one example, the processing method can include instance whitening. A first feature parameter and a second feature parameter of instance whitening are calculated via the following formulas:

$${μ}_{iw} = \frac{1}{HW} {X}_{n} \cdot 1 ;$$

$${Σ}_{iw} = \frac{1}{HW} ( {X}_{n} - μ \cdot {1}^{T} ) {( {X}_{n} - μ \cdot {1}^{T} )}^{T} + ɛ I ;$$

where is the first feature parameter (such as average vector) of instance whitening, E is the second feature parameter (such as covariance matrix) of instance whitening, 1 is a column vector of all ones, I is an identity matrix, and ^{E} is a positive number.

In instance whitening, each image data is whitened separately, i.e., φ(Xₙ)ϕ(Xₙ)^{T}=I.

Batch normalization, also called batch standardization, is a technique used to improve performance and stability of artificial neural networks. Batch normalization is a technique that provides input of zero average/unit variance for any layer in a neural network. Batch normalization uses center and scale operations to make averages and variances of the whole batch of data to be 0 and 1, respectively. Therefore, an average vector of batch normalization is the same as the average vector of batch whitening, i.e., μ_{bn}=μ_{bw}. In addition, because batch normalization only needs to divide by the variance of the data without whitening, the covariance matrix only needs to preserve diagonal elements, that is, Σ_{bn}=diag(Σ_{bw}), where diag( ) refers to only preserving diagonal elements and setting off-diagonal elements to be 0.

Similarly, in instance normalization, each image data is processed separately, where μᵢₙμ_{iw} and Σᵢₙ=diag(Σ_{iw}).

Layer normalization uses an average vector and a variance matrix of all channels of each image data to normalize. Let μₗₙ and σₗₙ denote the average vector and the variance matrix, then μₗₙ=μₗₙ1 and ΣₗₙσₗₙI.

After the first feature parameters and the second feature parameters are obtained, the method proceeds to operation 102.

At 102, a first weighted average of the first feature parameters is determined according to a weight coefficient of each first feature parameter, and a second weighted average of the second feature parameters is determined according to a weight coefficient of each second feature parameter.

According to the implementation, the device for image processing can store the weight coefficients. After the at least two first feature parameters and the at least two second feature parameters are obtained, the first weighted average (i.e., the weighted average of the at least two first feature parameters) is determined according to the weight coefficient of each first feature parameter, and the second weighted average (i.e., the weighted average of the at least two second feature parameters) is determined according to the weight coefficient of each second feature parameter.

In at least one implementation, whitening the image data to-be-processed is executed by a neural network. In mathematics, weight coefficients means different ratio coefficients given to show importance of certain quantities in the total.

In at least one implementation, for each processing method in the preset set, a weight coefficient of a first feature parameter of the processing method in the preset set is determined according to a normalized exponential function by utilizing a value of a first control parameter of the processing method in the neural network.

In at least one implementation, for each processing method in the preset set, a weight coefficient of a second feature parameter of the processing method in the preset set is determined according to the normalized exponential function by utilizing a value of a second control parameter of the processing method in the neural network.

The first control parameters and the second control parameters of the processing methods in the preset set are first control parameters and second control parameters of the neural network.

The normalization can be performed based on a normalized exponential function (such as the softmax function). Actually, the softmax function is normalization of the gradient logarithm of finite item discrete probability distribution. According to the implementation of this application, the control parameters are essentially ratios of statistics (such as average vector or covariance matrix) of different processing methods.

The above first control parameters and second control parameters may be obtained through learning based on stochastic gradient descent (SGD) approach and/or back propagation (BP) approach of the neural network.

BP approach is a learning approach suitable for multi-layer neural networks, which is based on the gradient descent method. The BP approach mainly includes: iteration of two processes (i.e., incentive propagation and weight update), until response of the network to input reaches a predetermined target range. The learning process of the BP approach includes: forward propagation process and back propagation process. In the forward propagation process, if an expected output value cannot be obtained at the output layer, the sum of squares of an error between an output value and the expected output value is taken as an objective function. Turn to the back propagation process, and a partial derivative of the objective function to a weight of each neuron is obtained layer by layer, constituting a gradient of the objective function to a weight vector, as the basis for weight modification, and learning of the network is finished during the weight modification. When the error reaches an expected value, the learning of the network ends.

After the above weighted averages are obtained, the method proceeds to operation 103.

At 103, the image data to-be-processed is whitened according to the first weighted average and the second weighted average.

Herein, whitening of the image data to-be-processed can be understood as: calculate the weighted average of the average vectors of the processing methods in the set of processing methods and the weighted average of the covariance matrices of the processing methods, and utilize an average vector obtained after weighted averaging and a covariance matrix obtained after weighted averaging as parameters of whitening to whiten the image data to-be-processed. As such, combination of different processing methods can be achieved, where weights (the above weight coefficients) of various processing methods can be obtained through training of a neural network.

It is to be noted, in the case that the image data to-be-processed includes more than one image data and the preset set of processing methods includes different processing methods, different image data may use different processing methods. For example, if the preset set includes batch whitening and batch normalization, a weighted average of average vectors of each mini-batch of image data is the same and a weighted average of covariance matrices of each mini-batch of image data is also the same, that is, whitening of the image data to-be-processed can be understood as processing each mini-batch of image data using a method similar as batch whitening. For another example, if the preset set includes batch whitening and instance whitening, a weighted average of average vectors of each image data is different and a weighted average of covariance matrices of each image data is also different, that is, whitening of the image data to-be-processed can be understood as processing each image data using a method similar as instance whitening.

In at least one implementation, each image data in the image data to-be-processed is whitened according to the first weighted average, the second weighted average, and the number of channels, the height, and the width of the image data to-be-processed.

In a CNN, data concerned usually have four dimensions, X ∈ R^{C×NHW} is a batch of image data, where N, C, H, and W respectively represent the number of image data, the number of channels, the height, and the width of the image data. Here N, H, and W are viewed in a single dimension for convenience. Xₙ ∈ R^{C×HW} is n-th image data (which can be understood as sample data in training process) in the batch of image data, then whitening on this image data can be denoted by:

ϕ(Xₙ)=Σ^{-1/2}(Xₙ−μ·1^{T});

where μ and Σ are respectively an average vector and a covariance matrix calculated from this image data and 1 is a column vector of all ones. For different whitening methods and normalization methods, μ and Σ can be calculated by using different image data. For example, for batch whitening and batch normalization, μ and Σ are calculated by using each batch of image data; for layer normalization, instance normalization, and instance whitening, μ and Σ are calculated by using each image data.

Furthermore, the inverse square root of the covariance matrix in SW(Xₙ) can be obtained by zero-phase component analysis (ZCA) whitening or principal component analysis (PCA) whitening. In an example, the inverse square root of the covariance matrix can be obtained through ZCA whitening, that is:

σ^{-1/2}=DΛ^{-1/2}D^{T}

where Λ=diag(σ₁, . . . ,σ_{c}) and D=[d₁, . . . , d_{c}] are respectively eigenvalues and eigenvectors of Σ, i.e., Σ=DAD^{T}, which can be obtained via eigen decomposition.

The above eigen decomposition is also called spectral decomposition, which is a method of decomposing a matrix into a product of matrices represented by its eigenvalues and eigenvectors.

For example, PCA whitening ensures that the variance of each dimension of data is 1, while ZCA whitening ensures that the variance of each dimension of data is the same. PCA whitening can be used for dimensionality reduction or de-correlation, while ZCA whitening is mainly used for de-correlation and renders whitened data as close as possible to original input data.

It can be understood that, in operation 102, a target average vector and a target covariance matrix that are used for final whitening are obtained, and the target average vector and the target covariance matrix are calculated through weighted averaging of different feature parameters of whitening and normalization methods corresponding to various image data. Based on the target average vector and the target covariance matrix, whitening can be achieved.

A formula for whitening the image data to-be-processed can be:

$$SW ( {X}_{n} ) = {\hat{Σ}}^{- 1 / 2} ( {X}_{n} - \hat{μ} ) ;$$

where Xₙ is n-th image data in the image data to-be-processed, Xₙ ∈ R^{C×HW}, \hat{μ} is the average vector obtained after weighted averaging (i.e., the target average vector), \hat{Σ} is a covariance matrix obtained after weighted averaging (i.e., the target covariance matrix), and C, H, and W respectively represent the number of channels, the height, and the width of the image data.

In an application scenario, if the preset set of processing methods includes batch whitening and batch normalization and the image data to-be-processed includes more than one image data, a weighted average of average vectors of each mini-batch of image data is the same but weighted averages of average vectors of different batches of image data are different; a weighted average \hat{μ} of covariance matrices of each mini-batch of image data is the same but weighted averages \hat{μ} of covariance matrices of different batches of image data are different. That is, whitening of the image data to-be-processed can be understood as performing batch whitening on each mini-batch of image data by using the weighted average of average vectors and the weighted average \hat{μ} of covariance matrices of each mini-batch of image data respectively as an average vector and a covariance matrix of batch whitening.

In another application scenario, if the preset set of processing methods includes at least one of batch whitening and batch normalization and at least one of layer normalization, instance normalization, and instance whitening, a weighted average of average \hat{μ} vectors of each image data is different and a weighted average \hat{Σ} of covariance matrices of each image data is also different. That is, whitening of the image data to-be-processed can be understood as performing instance whitening on each image data by using the weighted average of average vectors and the weighted average \hat{Σ} of covariance matrices of each image data respectively as an average vector and a covariance matrix of instance whitening.

In at least one example, the above image data to-be-processed may include image data collected by various terminal devices. For example, facial image data collected by cameras in autonomous driving, monitored image data collected in a monitoring system, video image data to-be-analyzed during intelligent video analysis, and facial image data collected from face recognition products. In an example, for photos to-be-beautified in a mobile terminal, the above method can be applied to a beauty application installed in the mobile terminal, to improve accuracy of image processing, for example, achieve better performance in image classification, semantic segmentation, image style transfer, and other aspects.

At present, normalization method or whitening method is in general used separately, preventing various methods from benefiting from each other. Moreover, various normalization and whitening methods increase space and difficulty of model design.

According to the method for image processing of the implementations, it is possible to unify different normalization and whitening methods in a single layer (or, in a general form), such as batch normalization, batch whitening, instance normalization, instance whitening, layer normalization, and other methods, adaptively learn ratios of various normalization and whitening methods, and implement end-to-end training with CNN.

According to the implementations, for each processing method in the preset set of processing methods, the first feature parameter and the second feature parameter are determined according to the image data to-be-processed, where the preset set includes at least two processing methods selected from whitening methods and/or normalization methods, and the image data to-be-processed includes at least one image data. The first weighted average of the first feature parameters is determined according to the weight coefficient of each first feature parameter, and the second weighted average of the second feature parameters is determined according to the weight coefficient of each second feature parameter. The image data to-be-processed is whitened according to the first weighted average and the second weighted average. As such, various processing methods in image processing (such as normalization and/or whitening methods) can be integrated and effect of image processing can be improved.

In at least one implementation, operation 103 is executed by a neural network. For each processing method in the preset set, a weight coefficient of a first feature parameter of a processing method in the preset set is determined by using a value of a first control parameter of the processing method in the neural network according to a normalized exponential function. For each processing method in the preset set, a weight coefficient of a second feature parameter of the processing method in the preset set is determined by using a value of a second control parameter of the processing method in the neural network according to the normalized exponential function.

In an example, a weight coefficient ωₖ of a first feature parameter of a processing method can be calculated through the following formula:

$${ω}_{k} = \frac{{e}^{{λ}_{k}}}{{\sum }_{z ∈ Ω} {e}^{{λ}_{z}}} ;$$

where μis the first control parameter and Ω is the preset set, for example, Q={bw, iw, bn, in, ln}.

Similarly, a weight coefficient ωₖ′ of a second feature parameter of the processing method can be calculated through the following formula:

$${ω}_{k}^{′} = \frac{{e}^{{λ}_{k}^{′}}}{{\sum }_{z ∈ Ω} {e}^{{λ}_{z}}} ;$$

where λₖ′ is the second control parameter and Ω is the preset set.

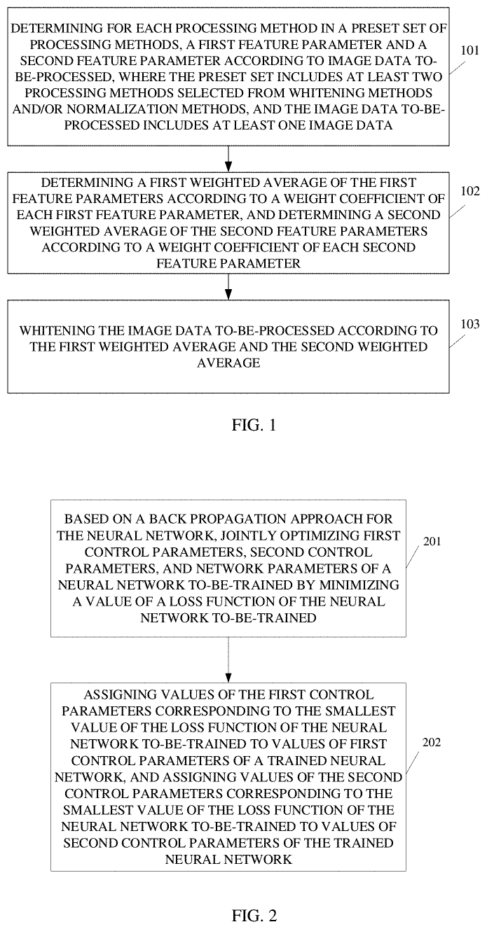

In at least one implementation, the method in FIG. 2 is applied to obtain first control parameters and second control parameters of various processing methods in the preset set (i.e., first control parameters and second control parameters of the neural network).

At 201, based on a back propagation approach for the neural network, first control parameters, second control parameters, and network parameters of a neural network to-be-trained are jointly optimized by minimizing a value of a loss function of the neural network to-be-trained.

In the implementation, the control parameters are essentially ratios of statistics (such as average vector or covariance matrix) of different processing methods. In an example, the above first control parameters and second control parameters may be obtained through learning based on SGD approach and BP approach of CNN during training the neural network.

The neural network is trained as follows.

In at least one implementation, the neural network to-be-trained whitens image data for training according to the first weighted average and the second weighted average, and outputs a prediction result.

In at least one implementation, the value of the loss function of the neural network to-be-trained is determined according to the prediction result output by the neural network to-be-trained and an annotation result of the image data for training.

In at least one implementation, values of the first control parameters, the second control parameters, and the network parameters of the neural network to-be-trained are adjusted according to the value of the loss function of the neural network to-be-trained.

In at least one implementation, an initial value of a first control parameter of a first processing method in the preset set is a first preset value, and an initial value of a second control parameter of the first processing method in the preset set is a second preset value. In an example, before training the neural network (such as CNN), the initial value of the first control parameter and the initial value of the second control parameter can be set in advance, for example, both the first preset value and the second preset value are set to be 1. At the beginning of training, a weight coefficient of a first feature parameter of the first processing method is calculated according to the initial value of the first control parameter of the first processing method, and a weight coefficient of a second feature parameter of the first processing method is calculated according to the initial value of the second control parameter of the first processing method. As such, at the beginning of training, the first weighted average of the first feature parameters of various processing methods and the second weighted average of the second feature parameters of various processing methods can be calculated. Thereafter, training of the neural network is started. The first processing method can be any one processing method in the preset set of processing methods.

During training of the neural network, various first control parameters, various second control parameters, and various network parameters of the neural network are iteratively updated by using the value of the loss function through SGD approach and BP approach. Repeat the above training process until the value of the loss function is minimized, and in this case training of the neural network is completed.

At 202, values of the first control parameters corresponding to the smallest value of the loss function of the neural network to-be-trained are assigned to values of first control parameters of a trained neural network, and values of the second control parameters corresponding to the smallest value of the loss function of the neural network to-be-trained are assigned to values of second control parameters of the trained neural network.

Values of the above parameters are adjusted according to the above the value of the loss function of the neural network to-be-trained. When the value of the loss function is the smallest, training of the neural network is completed. After the neural network is trained, various first control parameters, various second control parameters, and various network parameters of the neural network are learned. In testing (or inference) or in actual image processing, these parameters are fixed. In an example, during training of the neural network, forward calculation and back propagation operations are required, while in testing or in actual image processing, only forward calculation is required, that is, an image is input and then a processing result is obtained.

In an example, the image data for training and the annotation result of the image data for training are used to train the neural network, and then the trained neural network is used to process image data collected, for object recognition in the image. Different normalization and whitening methods or operations can be combined, such that CNN can adaptively learn ratios of various normalization and whitening methods according to specific tasks. It is possible to combine advantages of various methods and achieve automatic selection of normalization and whitening methods.

In application, thanks to rich statistics, the software can work not only in high-level vision tasks, but also in low-level vision tasks like image style transfer.

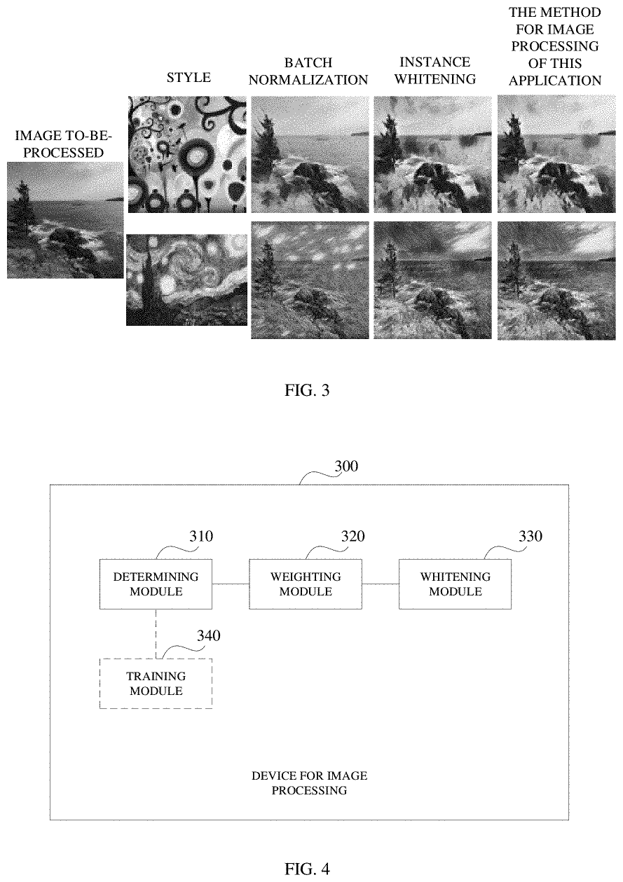

FIG. 3 is a schematic diagram illustrating visualization of style transfer using different normalization layers according to implementations. A popular style transfer approach is used for style transfer of an image to-be-processed. It has an image stylizing network trained with the content loss and style loss calculated by a loss network, which can use different image normalization and whitening processing. The MS-COCO dataset is used while the style images selected are candy and starry night. Follow the same training method as in the above style transfer approach, and adopt different normalization layers (e.g., batch normalization, instance whitening, and method for image processing herein) for the image stylizing network. That is, in FIG. 3, images at the second row are schematic diagrams of effect after applying different processing methods, and images at the first row are schematic diagrams of effect along with style transfer.

As illustrated in FIG. 3, batch normalization produces poor stylization images while instance whitening gives relatively satisfactory effect. Compared with instance whitening, in the method for image processing of the implementations of this application, the set of processing methods includes batch normalization and instance whitening, ratios of batch normalization and instance whitening have been determined by learning of the neural network, and the method for image processing herein have the best image processing effect. That is, the method for image processing herein can realize image processing by incorporating appropriate processing methods according to tasks.

In general, since normalization method or whitening method is used separately, it is difficult to combine advantages of various methods. Moreover, various normalization and whitening methods increase space and difficulty of design of neural network models. Compared with a convolutional neural network that only uses a certain normalization method or whitening method, the method for image processing herein can achieve adaptive learning of the ratios of various normalization and whitening methods, alleviate the need for manual design, combine advantages of various methods, and present better performance on various computer vision tasks.

In at least one example, the above image data to-be-processed may include image data collected by various terminal devices. For example, facial image data collected by cameras in autonomous driving, monitored image data collected in a monitoring system, video image data to-be-analyzed during intelligent video analysis, and facial image data collected from face recognition products. In an example, for photos to-be-beautified in a mobile terminal, the above method can be applied to a beauty application installed in the mobile terminal, to improve accuracy of image processing, for example, achieve better performance in image classification, semantic segmentation, image style transfer, and other aspects.

In practical applications, the image processing of the implementations of this application can be applied after convolutional layers of a convolutional neural network, which can be understood as a switchable whitening layer of the convolutional neural network, or applied to anywhere in the convolutional neural network. The difference between the switchable whitening layer and a traditional whitening layer is that the convolutional neural network with the switchable whitening layer can adaptively learn the ratios of various normalization and whitening methods according to training data in training stage, to obtain the best ratio.

The foregoing solution of the implementations of the disclosure is mainly described from the viewpoint of execution process of the method. It can be understood that, in order to implement the above functions, the electronic device includes hardware structures and/or software modules corresponding to the respective functions. Those of ordinary skill in the art should readily recognize that, in combination with the example units and scheme steps described in the implementations disclosed herein, the present disclosure can be implemented in hardware or a combination of the hardware and computer software. Whether a function is implemented by way of the hardware or hardware driven by the computer software depends on the particular application and design constraints of the technical solution. Those of ordinary skill in the art may use different methods to implement the described functions for each particular application, but such implementation should not be considered as beyond the scope of the present disclosure.

According to the implementations of the disclosure, functional units may be divided for the user device equipment in accordance with the foregoing method examples. For example, each functional unit may be divided according to each function, and two or more functions may be integrated in one processing unit. The above-mentioned integrated unit can be implemented in the form of hardware or software functional units. It should be noted that the division of units in the implementations of the present disclosure is schematic, and is merely a logical function division, and there may be other division manners in actual implementation.

FIG. 4 is a schematic structural diagram illustrating a device for image processing according to implementations. As illustrated in FIG. 4, the device 300 for image processing includes a determining module 310, a weighting module 320, and a whitening module 330.

The determining module 310 is configured to determine, for each processing method in a preset set of processing methods, a first feature parameter and a second feature parameter according to image data to-be-processed, where the preset set includes at least two processing methods selected from whitening methods and/or normalization methods, and the image data to-be-processed includes at least one image data.

The weighting module 320 is configured to determine a weighted average of at least two first feature parameters according to a weight coefficient of each first feature parameter, and determine a weighted average of at least two second feature parameters according to a weight coefficient of each second feature parameter.

The whitening module 330 is configured to whiten the image data to-be-processed according to the weighted average of the at least two first feature parameters and the weighted average of the at least two second feature parameters.

In at least one implementation, the first feature parameter is an average vector and the second feature parameter is a covariance matrix.

In at least one implementation, a function of the whitening module 330 is executed by a neural network. For each processing method in the preset set, a weight coefficient of a first feature parameter of the processing method in the preset set is determined according to a normalized exponential function by utilizing a value of a first control parameter of the processing method in the neural network. For each processing method in the preset set, a weight coefficient of a second feature parameter of the processing method in the preset set is determined according to the normalized exponential function by utilizing a value of a second control parameter of the processing method in the neural network.

In at least one implementation, the device 300 for image processing further includes a training module 340. First control parameters and second control parameters of the processing methods in the preset set are obtained through training of the neural network by the training module. The training module 340 is configured to: based on a back propagation approach for the neural network, jointly optimize first control parameters, second control parameters, and network parameters of the neural network by minimizing a value of a loss function of the neural network; assign values of the first control parameters corresponding to the smallest value of the loss function of the neural network to values of the first control parameters of the neural network; and assign values of the second control parameters corresponding to the smallest value of the loss function of the neural network to values of the second control parameters of the neural network.

In at least one implementation, the training module 340 is configured to: whiten image data for training according to the weighted average of the first feature parameters and the weighted average of the second feature parameters of the processing methods in the preset set in a neural network to-be-trained, and output a prediction result, where an initial value of a first control parameter of a first processing method in the preset set is a first preset value, and an initial value of a second control parameter of the first processing method in the preset set is a second preset value; determine a value of a loss function of the neural network to-be-trained according to the prediction result output by the neural network to-be-trained and an annotation result of the image data for training; and adjust values of first control parameters, second control parameters, and network parameters of the neural network to-be-trained according to the value of the loss function of the neural network to-be-trained.

In at least one implementation, the whitening module 330 is configured to whiten each image data in the image data to-be-processed according to the weighted average of the at least two first feature parameters, the weighted average of the at least two second feature parameters, and the number of channels, the height, and the width of the image data to-be-processed.

In at least one implementation, the normalization method includes at least one of: batch normalization, instance normalization, and layer normalization.

In at least one implementation, the whitening method includes at least one of: batch whitening and instance whitening.

The device 300 for image processing of the implementations of FIG. 4 can execute part or all of the methods of the implementations of FIG. 1 and/or FIG. 2.

According to the implementations of FIG. 4, the device 300 can determine, for each processing method in the preset set of processing methods, the first feature parameter and the second feature parameter according to the image data to-be-processed, where the preset set includes at least two processing methods selected from whitening methods and/or normalization methods, and the image data to-be-processed includes at least one image data. The device 300 further can determine the weighted average of the at least two first feature parameters according to the weight coefficient of each first feature parameter, and determine the weighted average of the at least two second feature parameters according to the weight coefficient of each second feature parameter. The device 300 further can whiten image data to-be-processed according to the weighted average of the at least two first feature parameters and the weighted average of the at least two second feature parameters. It is possible to achieve switchable whitening in image processing and improve effect of image processing.

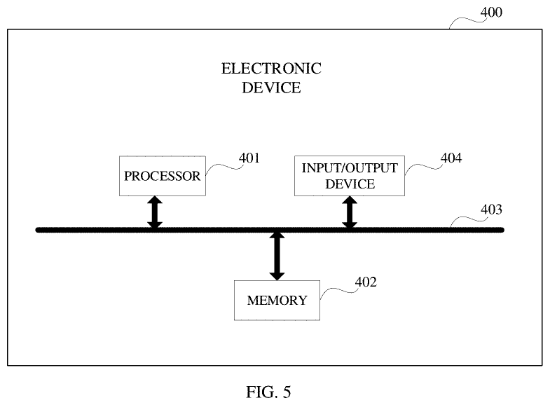

FIG. 5 is a schematic structural diagram illustrating an electronic device according to implementations. As illustrated in FIG. 5, the electronic device 400 includes at least one processor (such as a processor) 401 and a non-transitory computer readable storage (such as a memory 402). The electronic device 400 may also include a bus 403. The processor 401 and the memory 402 may be coupled with each other through the bus 403, where the bus 403 may be a peripheral component interconnect (PCI) bus or an extended industry standard architecture (EISA) bus. The bus 403 can include an address bus, a data bus, a control bus, and so on. For ease of presentation of the bus, only one thick line is used in FIG. 5, but it does not mean that there is only one bus or one type of bus. The electronic device 400 may further include an input/output device 404, where the input/output device 404 may include a display screen, such as a liquid crystal display screen. The memory 402 is used to store at least one computer executable instruction (such as one or more programs containing instructions). The processor 401 is configured to invoke instructions stored in the memory 402 to execute part or all of the method operations of the implementations of FIG. 1 and FIG. 2. The processor 401 may correspondingly implement functions of various modules in the electronic device 400 of FIG. 5.

According to the implementations, the electronic device 400 can determine, for each processing method in the preset set of processing methods, the first feature parameter and the second feature parameter according to the image data to-be-processed, where the preset set includes at least two processing methods selected from whitening methods and/or normalization methods, and the image data to-be-processed includes at least one image data. The electronic device 400 further can determine the first weighted average of the first feature parameters according to the weight coefficient of each first feature parameter, and determine the second weighted average of the second feature parameters according to the weight coefficient of each second feature parameter. The electronic device 400 further can whiten image data to-be-processed according to the first weighted average and the second weighted average. It is possible to achieve switchable whitening in image processing and improve effect of image processing.

Implementations of the present disclosure further provide a computer storage medium. The computer storage medium may store computer programs for electronic data interchange. When executed, the computer programs cause a computer to accomplish all or part of the operations of any of method described in the above method implementations.

It is to be noted that, for the sake of simplicity, the foregoing method implementations are described as a series of action combinations, however, it will be appreciated by those of ordinary skill in the art that the present disclosure is not limited by the sequence of actions described. That is because that, according to the present disclosure, certain steps or operations may be performed in other order or simultaneously. Besides, it will be appreciated by those of ordinary skill in the art that the implementations described in the specification are exemplary implementations and the actions and modules involved are not necessarily essential to the present disclosure.

In the foregoing implementations, the description of each implementation has its own emphasis. For the parts not described in detail in one implementation, reference may be made to related descriptions in other implementations.

In the implementations of the disclosure, it should be understood that the device disclosed in implementations provided herein may be implemented in other manners. For example, the device/apparatus implementations described above are merely illustrative; for instance, the division of the unit is only a logical function division and there can be other manners of division during actual implementations, for example, multiple units or components may be combined or may be integrated into another system, or some features may be ignored, omitted, or not performed. In addition, coupling or communication connection between each illustrated or discussed component may be direct coupling or communication connection via some interfaces, or may be indirect coupling or communication among devices or units, and may be electrical connection, or other forms of connection.

The units described as separate components may or may not be physically separate, the components illustrated as units may or may not be physical units, that is, they may be in the same place or may be distributed to multiple network elements. Part or all of the units may be selected according to actual needs to achieve the purpose of the technical solutions of the implementations.

In addition, the functional units in various implementations of the present disclosure may be integrated into one processing unit, or each unit may be physically present, or two or more units may be integrated into one unit. The above-mentioned integrated unit can be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device and so on) to perform all or part of the operations described in the various implementations of the present disclosure. The memory includes various medium capable of storing program codes, such as a universal serial bus (USB), a read-only memory (ROM), a random access memory (RAM), a removable hard disk, Disk, compact disc (CD), or the like.

It will be understood by those of ordinary skill in the art that all or a part of the various methods of the implementations described above may be accomplished by means of a program to instruct associated hardware, the program may be stored in a computer readable memory, which may include a flash memory, a ROM, a RAM, Disk or CD, and so on.

The implementations of this application are described in detail above. Some examples are used herein to illustrate the principle and implementation manner of the disclosure. The implementations are described to help understand the method and core idea of the disclosure. For those of ordinary skill in the art, according to the idea of the disclosure, there will be changes in specific implementation manner and application scope. In conclusion, the contents of this specification should not be construed as limiting the disclosure.

What is claimed is:

1. A method for image processing, the method comprising:
for each processing method in a preset set of processing methods, determining a first feature parameter and a second feature parameter according to image data to-be-processed, wherein the preset set comprises at least two processing methods selected from whitening methods and/or normalization methods, and wherein the image data to-be-processed comprises at least one image data;
determining a first weighted average of the first feature parameters according to a weight coefficient of each first feature parameter, and determining a second weighted average of the second feature parameters according to a weight coefficient of each second feature parameter; and
whitening the image data to-be-processed according to the first weighted average and the second weighted average.

2. The method of claim 1, wherein the first feature parameter is an average vector, and wherein the second feature parameter is a covariance matrix.

3. The method of claim 1, wherein whitening the image data to-be-processed is executed by a neural network.

4. The method of claim 3, further comprising:
for each processing method in the preset set:
determining a weight coefficient of a first feature parameter of the processing method in the preset set according to a normalized exponential function by utilizing a value of a first control parameter of the processing method in the neural network; and
determining a weight coefficient of a second feature parameter of the processing method in the preset set according to the normalized exponential function by utilizing a value of a second control parameter of the processing method in the neural network.

5. The method of claim 4, further comprising obtaining first control parameters and second control parameters of the processing methods in the preset set, wherein obtaining the first control parameters and the second control parameters of the processing methods in the preset set comprises:
based on a back propagation approach for the neural network, jointly optimizing first control parameters, second control parameters, and network parameters of a neural network to-be-trained by minimizing a value of a loss function of the neural network to-be-trained;
assigning values of the first control parameters corresponding to a smallest value of the loss function of the neural network to-be-trained to values of first control parameters of a trained neural network; and
assigning values of the second control parameters corresponding to the smallest value of the loss function of the neural network to-be-trained to values of second control parameters of the trained neural network.

6. The method of claim 5, wherein based on the back propagation approach for the neural network, jointly optimizing the first control parameters, the second control parameters, and the network parameters of the neural network to-be-trained by minimizing the value of the loss function of the neural network to-be-trained comprises:
whitening, by the neural network to-be-trained, image data for training according to the first weighted average and the second weighted average, and outputting a prediction result by the neural network to-be-trained, wherein an initial value of a first control parameter of a first processing method in the preset set is a first preset value, and an initial value of a second control parameter of the first processing method in the preset set is a second preset value;
determining the value of the loss function of the neural network to-be-trained according to the prediction result output by the neural network to-be-trained and an annotation result of the image data for training; and
adjusting values of the first control parameters, the second control parameters, and the network parameters of the neural network to-be-trained according to the value of the loss function of the neural network to-be-trained.

7. The method of claim 5, wherein whitening the image data to-be-processed according to the first weighted average and the second weighted average comprises:
whitening each image data in the image data to-be-processed according to the first weighted average, the second weighted average, and the number of channels, the height, and the width of the image data to-be-processed.

8. The method of claim 1, wherein at least one of the normalization methods comprises at least one of: batch normalization, instance normalization, and layer normalization.

9. The method of claim 1, wherein the whitening method comprises at least one of: batch whitening and instance whitening.

10. An electronic device, comprising:
at least one processor; and
a non-transitory computer readable storage, coupled to the at least one processor and having stored thereon at least one computer executable instruction which, in response to execution by the at least one processor, causes the at least one processor to:
determine, for each processing method in a preset set of processing methods, a first feature parameter and a second feature parameter according to image data to-be-processed, wherein the preset set comprises at least two processing methods selected from whitening methods and/or normalization methods, and wherein the image data to-be-processed comprises at least one image data;
determine a first weighted average of the first feature parameters according to a weight coefficient of each first feature parameter, and determine a second weighted average of the second feature parameters according to a weight coefficient of each second feature parameter; and
whiten the image data to-be-processed according to the first weighted average and the second weighted average.

11. The electronic device of claim 10, wherein the first feature parameter is an average vector, and wherein the second feature parameter is a covariance matrix.

12. The electronic device of claim 10, wherein the at least one processor employs a neural network to whiten the image data to-be-processed.

13. The electronic device of claim 12, wherein in response to execution of the at least one computer executable instruction, the at least one processor is further configured to:
for each processing method in the preset set:
determine a weight coefficient of a first feature parameter of the processing method in the preset set according to a normalized exponential function by utilizing a value of a first control parameter of the processing method in the neural network; and
determine a weight coefficient of a second feature parameter of the processing method in the preset set according to the normalized exponential function by utilizing a value of a second control parameter of the processing method in the neural network.

14. The electronic device of claim 13, wherein first control parameters and second control parameters of the processing methods in the preset set are obtained through training of the neural network, and wherein in response to execution of the at least one computer executable instruction, the at least one processor is further configured to:
based on a back propagation approach for the neural network, jointly optimize first control parameters, second control parameters, and network parameters of a neural network to-be-trained by minimizing a value of a loss function of the neural network to-be-trained;
assign values of the first control parameters corresponding to a smallest value of the loss function of the neural network to-be-trained to values of first control parameters of a trained neural network; and
assign values of the second control parameters corresponding to the smallest value of the loss function of the neural network to-be-trained to values of second control parameters of the trained neural network.

15. The electronic device of claim 14, wherein the at least one processor configured to, based on the back propagation approach for the neural network, jointly optimize the first control parameters, the second control parameters, and the network parameters of the neural network to-be-trained by minimizing the value of the loss function of the neural network to-be-trained, is configured to:
whiten image data for training according to the first weighted average of the first feature parameters and the second weighted average of the second feature parameters of the processing methods in the preset set in the neural network to-be-trained, and output a prediction result, wherein an initial value of a first control parameter of a first processing method in the preset set is a first preset value, and an initial value of a second control parameter of the first processing method in the preset set is a second preset value;
determine the value of the loss function of the neural network to-be-trained according to the prediction result output by the neural network to-be-trained and an annotation result of the image data for training; and
adjust values of the first control parameters, the second control parameters, and the network parameters of the neural network to-be-trained according to the value of the loss function of the neural network to-be-trained.

16. The electronic device of claim 14, wherein the at least one processor configured to whiten the image data to-be-processed according to the first weighted average and the second weighted average is configured to:
whiten each image data in the image data to-be-processed according to the first weighted average, the second weighted average, and the number of channels, the height, and the width of the image data to-be-processed.

17. The electronic device of claim 10, wherein at least one of the normalization methods comprises at least one of: batch normalization, instance normalization, and layer normalization.

18. The electronic device of claim 10, wherein the whitening method comprises at least one of: batch whitening and instance whitening.

19. A non-transitory computer readable storage medium that stores a computer program which, in response to execution by a processor, causes the processor to implement:
for each processing method in a preset set of processing methods, determining a first feature parameter and a second feature parameter according to image data to-be-processed, wherein the preset set comprises at least two processing methods selected from whitening methods and/or normalization methods, and wherein the image data to-be-processed comprises at least one image data;
determining a first weighted average of the first feature parameters according to a weight coefficient of each first feature parameter, and determining a second weighted average of the second feature parameters according to a weight coefficient of each second feature parameter; and
whitening the image data to-be-processed according to the first weighted average and the second weighted average.

20. The computer readable storage medium of claim 19, wherein:
whitening the image data to-be-processed is executed by a neural network;
the computer program, in response to execution by the processor, further causes the processor to implement:
for each processing method in the preset set:
determining a weight coefficient of a first feature parameter of the processing method in the preset set according to a normalized exponential function by utilizing a value of a first control parameter of the processing method in the neural network; and
determining a weight coefficient of a second feature parameter of the processing method in the preset set according to the normalized exponential function by utilizing a value of a second control parameter of the processing method in the neural network.
